(19) United States
(12) Patent Application Publication
(10) Pub. No.: US 2021/0372664 A1
(43) Pub. Date: Dec. 2, 2021

(54) CONDENSATE DRAIN FOR WATER HEATER

(71) Applicant: BECKETT THERMAL SOLUTIONS, North Ridgeville, OH (US)

(72) Inventor: MICHAEL J. O'DONNELL, Avon, OH (US)

(21) Appl. No.: 17/241,161

(22) Filed: Apr. 27, 2021

Related U.S. Application Data
(60) Provisional application No. 63/030,357, filed on May 27, 2020.

(51) Int. Cl. F24H 8/00; F24H 9/18

(52) U.S. Cl. CPC F24H 8/006; F24H 9/1836

(57) ABSTRACT

An assembly for a water heater having a burner includes a tube extending longitudinally along a centerline from a first end adjacent the burner to a second end. The first end includes a flared portion extending away from the centerline. A partition is provided downstream of the burner and includes an opening having a curved flange defining an opening for receiving the flared portion of the tube.

### RELATED APPLICATION

This applications claims priority to U.S. Provisional Application Ser. No. 63/030,357, filed May 27, 2020, the entirety of which is incorporated herein by reference.

### TECHNICAL FIELD

The present invention relates generally to water heaters and, more specifically, to a condensate disposal system for water heaters.

### BACKGROUND

Storage-type water heaters have certain operating conditions in which condensation can be produced in relatively large quantities. One such condition is when the water tank is first installed and filled with cold water. Another is when the tank runs out of hot water during a long/large water draw. Due to manufacturing considerations, a portion of the flue tube in the water tank protrudes out from the bottom of the tank. This can cause the condensate to drip down from the bottom edge of the tube and directly onto the burner below it. As a result, the condensate can cause pilot outage (nuisance shut-off), bad combustion (high CO), and/or negatively affect the burner lifespan.

### SUMMARY

In one example, an assembly for a water heater having a burner includes a tube extending longitudinally along a centerline from a first end adjacent the burner to a second end. The first end includes a flared portion extending away from the centerline. A partition is provided downstream of the burner and includes an opening having a curved flange defining an opening for receiving the flared portion of the tube.

In another example, an assembly for a water heater having a burner includes a tube extending longitudinally along a centerline from a first end adjacent the burner to a second end. The first end includes a flared portion extending away from the centerline. A partition is provided downstream of the burner and includes an opening having a curved flange defining an opening for receiving the flared portion of the tube such that the flared portion of the tube extends into the partition and cooperates with the curved flange to direct condensate in the tube away from the burner.

Other objects and advantages and a fuller understanding of the invention will be had from the following detailed description and the accompanying drawings.

### BRIEF DESCRIPTION OF THE DRAWINGS

FIG. 1 is a schematic illustration of a water heater having an example condensate disposal system.

FIG. 2 is an enlarged view of a portion of FIG. 1.

### DETAILED DESCRIPTION

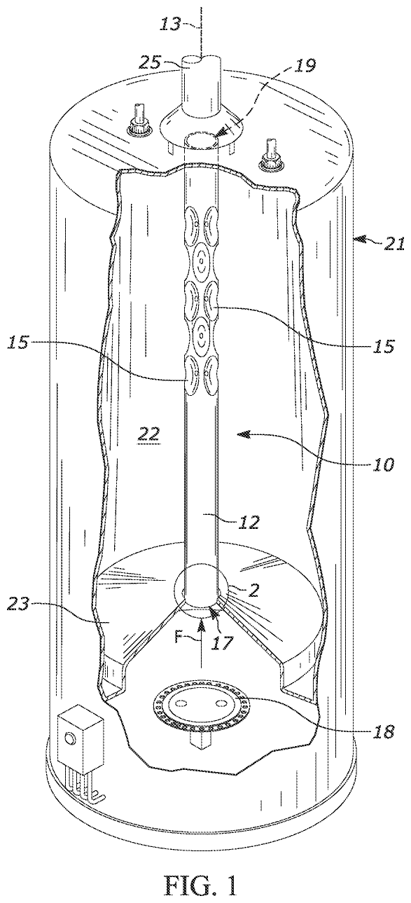

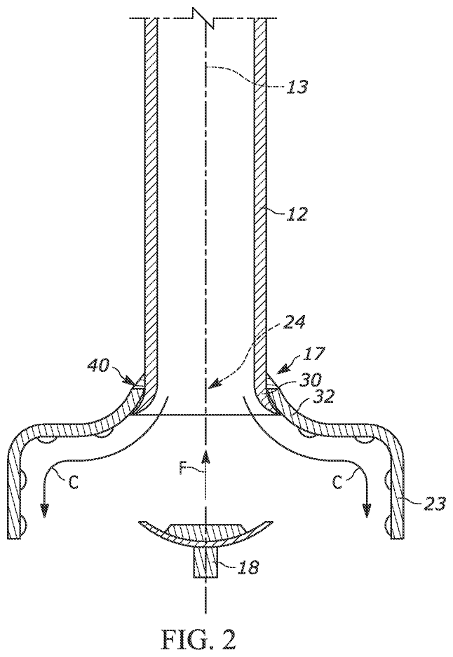

The present invention relates generally to water heaters and, more specifically, to a condensate disposal system for water heaters. Referring to FIGS. 1-2 a gas-heated residential water heater 21 is shown and includes a water heating chamber 22 in which water to be heated (not shown) is stored.

A gas burner 18 is provided at the bottom of the water heater 21 behind a partition 23 in the water heater separating the gas burner from the heating chamber 22. The partition 23 has a first side (bottom as shown) facing the burner 18 and a second side (top as shown) facing water stored in the water heating chamber 22.

A heat exchanger 10 extends longitudinally through the heating chamber 22 for supplying heat to the stored water therein. In one example, the heat exchanger 10 constitutes a flue tube 12 for transferring heat from flue gases produced by the gas burner 18 to the water in the heating chamber 22.

The flue tube 12 extends longitudinally along a centerline 13 from a first/inlet end 17 or a second/exit end 19. The first end 17 extends through the partition 23 and is in fluid communication with the gas burner 18. The second end 19 is in fluid communication with an exhaust or vent system 25 at the top of the water heater. The first tube 12 can be formed from metal or any material having high thermal conductivity. Indentations 15 can be formed in the flue tube 12 and extend towards the centerline 13. The indentations 15 restrict/slow down fluid flow in the flue tube 12 to increase scrubbing of the flue tube wall.

It will be appreciated that the indentations shown can alternatively be omitted (not shown) such that the flue tube 12 has a straight, uninterrupted sidewall. In such cases, a conventional sheet metal baffle or the like (not shown) can be provided in the interior of the flue tube 12.

Referring to FIG. 2, the inlet end 17 of the flue tube 12 includes a flared or outwardly curved portion 30. More specifically, the longitudinal extent of the inlet end 17 can have a curved or frustoconical configuration extending away from the centerline 13. Alternatively, the portion 30 can be squared off with more a generally straight/linear profile rather than curved (not shown). In any case, the partition 23 includes an opening 24 defined by a flange or projection 32 shaped similar to the flared portion 30 and configured to receive the flared portion 30. Consequently, the flared portion 30 can extend into the flange 32 of the partition 23 and therefore be positioned on the first (bottom) side thereof. The flared portion 30 and projection 32 can cooperate to define a continuous or substantially continuous surface, i.e., there can be smooth/seamless transition between the inner surface of the flared portion and the inner surface of the projection.

When assembling the water heater 21, the outlet end 19 of the flue tube 12 is inserted through the opening 24 and the flue tube 12 passed through the partition 23 until the flared portion 30 abuts the flange 32. The matching contours prevent the inlet end 17 from passing entirely through the opening 24. Consequently, the flange 32 acts as a hard stop for locating the flue tube 12 relative to the partition 23. The inner surfaces of the flared portion 30 and flange 32 automatically align with one another. The flange 32 and flared portion 30 can then be secured to one another by, for example, a weld 40 such that the flange and flared portion are flush with one another.

In operation, the gas burner 18 heats gases that move upward in the manner indicated by the arrows F through the partition 23 and into the flue tube 12. The heat from these gases F is conducted radially outward through the flue tube 12 to heat the water in the water heating chamber 22. During the aforementioned conditions, condensate can form along the interior of the flue tube 12. Gravity causes the condensate to flow downward (in a direction opposite the direction F) towards the burner 18.

Since the inlet end 17 of the flue tube 12 includes the flared portion 30, which has the same or substantially similar contour as the flange 32, the condensate flows along the flared portion and subsequently along the flange to the side wall of the partition 23 in the manner indicated generally by the arrows C. In other words, the interface and alignment between the flue tube 12 and partition 23 causes the condensate to flow outward—away from the centerline 13 upon entering the area adjacent the burner 18—instead of flowing along/parallel to the centerline into contact with the burner. As a result, the condensate will not negatively affect operation of the burner 18.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An assembly for a water heater having a burner, comprising:
a tube extending longitudinally along a centerline from a first end adjacent the burner to a second end, the first end including a flared portion extending away from the centerline; and
a partition downstream of the burner and including an opening having a curved flange defining an opening for receiving the flared portion of the tube.

2. The assembly recited in claim 1, wherein the flared portion is frustoconical.

3. The assembly recited in claim 1, wherein the partition has a first side facing the burner and a second side facing water stored in the water heater, the flared portion being positioned on the first side.

4. The assembly recited in claim 1, wherein the flared portion cooperates with the flange to direct condensate in the tube away from the burner.

5. The assembly recited in claim 1, wherein the flared portion of the tube extends into the curved flange of the partition.

6. The assembly recited in claim 1, wherein the flange and the flared portion have the same shape.

7. The assembly recited in claim 1, wherein the flared portion has a straight contour.

8. The assembly recited in claim 1, wherein the flared portion has a curved contour.

9. A water heater including the assembly recited in claim 1.

10. An assembly for a water heater having a burner, comprising:
a tube extending longitudinally along a centerline from a first end adjacent the burner to a second end, the first end including a flared portion extending away from the centerline; and
a partition downstream of the burner and including an opening having a curved flange defining an opening for receiving the flared portion of the tube such that the flared portion of the tube extends into the partition and cooperates with the curved flange to direct condensate in the tube away from the burner.

11. The assembly recited in claim 10, wherein the flared portion is frustoconical.

12. The assembly recited in claim 10, wherein the partition has a first side facing the burner and a second side facing water stored in the water heater, the flared portion being positioned on the first side.

13. The assembly recited in claim 10, wherein the flange and the flared portion have the same shape.

14. The assembly recited in claim 10, wherein the flared portion has a straight contour.

15. The assembly recited in claim 10, wherein the flared portion has a curved contour.

16. A water heater including the assembly recited in claim 10.
